(19) United States
(12) Patent Application Publication
(10) Pub. No.: US 2013/0315652 A1
(43) Pub. Date: Nov. 28, 2013

(54) Clamp

(71) Applicant: NEFAB AB, Jonkoping (SE)

(72) Inventor: Pontus Eding, Edsbyn (SE)

(73) Assignee: NEFAB AB, Jonkoping (SE)

(21) Appl. No.: 13/902,201

(22) Filed: May 24, 2013

(30) Foreign Application Priority Data
May 28, 2012 (EP) 12169683.5

(51) Int. Cl. F16B 5/06

(52) U.S. Cl. CPC F16B 5/0614
USPC 403/20

(57) ABSTRACT

A clamp (1) for interconnecting two plate-like members (16, 17) so as to make them together form a substantially rectangular corner has two legs (2, 3) resiliently connected to each other and making an angle being less than 90° with each other in a rest state of the clamp. Each leg has at an outer end thereof remote to a transition (4) to the other leg a member (7, 8) configured to engage a part of the said plate-like member in an interconnecting state of the clamp. At least one of said legs is provided with an opening designed to receive an end of an elongated tool member in said interconnecting state of the clamp for enabling removal of said clamp in said interconnecting state from said plate-like members by influencing that leg in the direction apart from the other leg.

### TECHNICAL FIELD OF THE INVENTION AND BACKGROUND ART

The present invention relates to a clamp for interconnecting two plate-like members so as to make them together form a substantially rectangular corner, said clamp having two legs resiliently connected to each other, making an angle being less than 90° with each other in a rest state of the clamp and being in a state of interconnecting said plate-like members configured to extend around a said corner while storing more potential energy than in said rest state and be located along an outer surface of the plate-like members, each leg having at an outer end thereof remote to a transition to the other leg a member configured to engage a part of a said plate-like member in said interconnecting state.

Clamps of this type are usually used for interconnecting a number of plate-like members, which may be arranged tightly against each other, for forming a container for packaging purposes. Thus, in such a case said plate-like members are walls, a bottom or a lid of a container. In the case of interconnecting six such plate-like members to each other a container having a parallelepipedic shape may be obtained. It is conceivable to have all or only some of said plate-like members of a container interconnected by clamps of the type defined above. It is possible to interconnect two such plate-like members by only one clamp or several such clamps. Said member of the clamp for engaging a part of a said plate-like member may be of any type, such as male or female and the part to engage of said plate-like member may also be of any type, such as a hole in the plate-like member, a groove therein or a projection formed by an element attached to said plate-like member.

A clamp of this type is known for example through the Swedish patent 513 684 C2.

Clamps of this type are preferably used for creating containers by interconnecting plate-like members therethrough, and when the container has been used for the transport of objects, the clamps may be unlocked and the plate-like members may be separated for getting disposed of or being sent back as a substantially flat package. Thus, it is of course desired to have a clamp of this type being easy to handle for interconnecting and disconnecting plate-like members and obtaining a reliable interconnection thereof.

### SUMMARY OF THE INVENTION

The object of the present invention is to provide a clamp of the type defined into the introduction enabling a simplified handling thereof in some respect compared to such clamps already known.

This object is according to the invention obtained by providing a clamp of the type defined in the introduction with the additional features: that at least one of said legs is provided with an opening designed to receive an end of an elongated tool member in said interconnecting state of the clamp for enabling removal of said clamp in said interconnecting state from said plate-like members by influencing that leg in the direction apart from the other leg and by that moving said engagement member out of engagement with said part of the plate-like member.

Thanks to the arrangement of said opening in at least one leg of the clamp the clamp may easily be brought from said interconnecting state to a state for disconnecting from a plate-like member by urging the leg in question apart from the other leg while increasing the potential energy of the clamp by use of a said tool member, such as possibly an ordinary screw driver.

According to an embodiment of the invention said opening is directed towards said transition of the legs to each other so as to enable support of said tool member by leg portions in the region of said transition while urging the two legs apart for obtaining said removal. It will thanks to this direction of said opening be possible to rapidly remove said clamp from the interconnecting state without any risk of causing any damage whatsoever on said plate-like member thanks to said support provided for a said tool member.

According to another embodiment of the invention the clamp comprises a member defining said opening and extending out from surrounding portions of said leg in the direction towards said transition. This means that this member may provide support for an end of a said tool member, so that this may act on said opening defining member without entering into contact with any plate-like member when bringing the clamp out of said interconnecting state, and a further development of this embodiment defines this possibility by the fact that said opening defining member has a surface thereof diverging from said surrounding leg portions and providing support for an end of a said tool member.

According to another embodiment of the invention the surface last mentioned of said opening defining member makes an angle with respect to said surrounding leg portions of 5°-30°, 5°-20° or 10°-15°. These are suitable values for a said angle for providing accurate support for a said end of a tool member for removing the clamp from said interconnecting state.

According to another embodiment of the invention said opening defining member is formed in one piece with said leg by a portion of leg material bent out from surrounding leg material portions, which results in low manufacturing costs of the clamp and a reliable function thereof.

According to another embodiment of the invention said clamp is made of one single flat material piece bent in said transition of one leg to the other, and the clamp is according to another embodiment of the invention made of metal, and in a further preferred embodiment of spring steel. Spring steel is a suitable material for this type of clamp, since it provides the resiliency needed and is able to withstand rather tough handling of for instance a container being loaded or unloaded. However, other materials than metal, such as plastic, for the clamp are possible.

According to another embodiment of the invention said two legs make an angle of 87°-60°, 85°-60°, 80°-60° or 80°-70° in said rest state of a minimum of potential energy stored. Such an angle in said rest state results in a substantial difference in shape of said clamp in the interconnecting state with respect to the rest state and a significantly difference in potential energy stored in the two states for reliably keeping the clamp in said interconnecting state once obtained.

According to another embodiment of the invention said engagement member is a male member, and this male member is according to a further development of this embodiment formed by an end of said leg projecting from adjacent leg portions while making an angle of approximately 90°, such as 80°-100°, therewith. Having an engagement member in the form of a male member at the outer end of each clamp leg makes it possible to omit unnecessary projections on said plate-like members, which instead may be provided with female members in the form of grooves or holes for engagement with said male members.

According to another embodiment of the invention said opening is located close to said outer end of said leg, such as at a distance thereto being less than ⅓, less than ¼, less than ⅕ or less than ⅙ of the distance to the transition of that leg to the other leg. Such a location of said opening results in a favourable lever when acting upon the clamp through said opening for removing the clamp from said interconnecting state making such removal easy.

According to another embodiment of the invention both legs of the clamp have a said opening, so that the one easiest to reach may be used for disconnecting the clamp from two plate-like members interconnected thereby.

The invention also relates to a container with at least a bottom and four walls interconnected while together forming substantially rectangular corners of the container, in which at least adjacent walls of said container are interconnected by at least one clamp according to the present invention.

Further advantages as well as advantageous features of the invention will appear from the following description.

### BRIEF DESCRIPTION OF THE DRAWINGS

With reference to the appended drawings, below follows a specific description of a clamp according to an embodiment of the invention cited as an example.

In the drawings:

FIG. 1 is a side-elevation view of a clamp according to an embodiment of the invention in a rest position of a minimum of potential energy stored thereby,

FIG. 2 is a perspective view of the clamp shown in FIG. 1,

FIG. 3 is a cross-section view of the clamp according to FIG. 1 in a state in which it interconnects two plate-like members,

FIG. 4 is a view illustrating how to remove a clamp from the interconnecting state shown in FIG. 3, and

FIG. 5 is a perspective view of a container having all six delimiting walls interconnected by means of clamps according to the present invention.

### DETAILED DESCRIPTION OF AN EMBODIMENT OF THE INVENTION

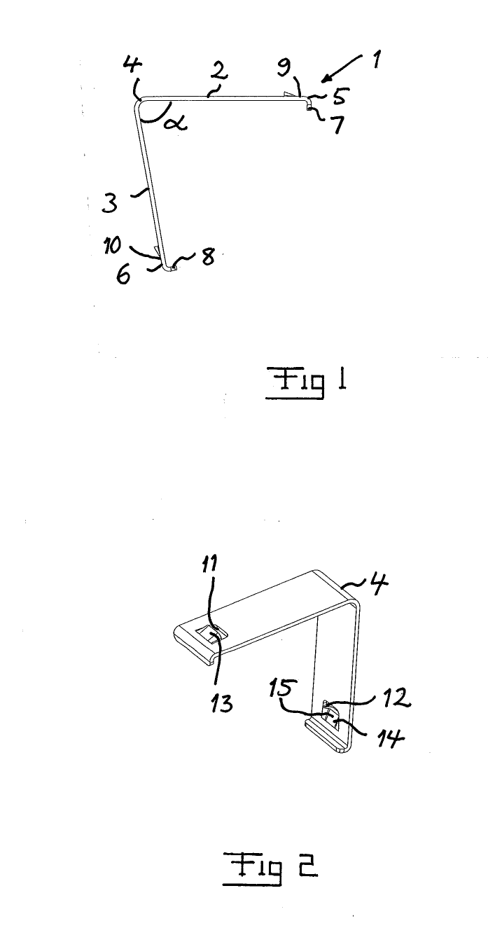

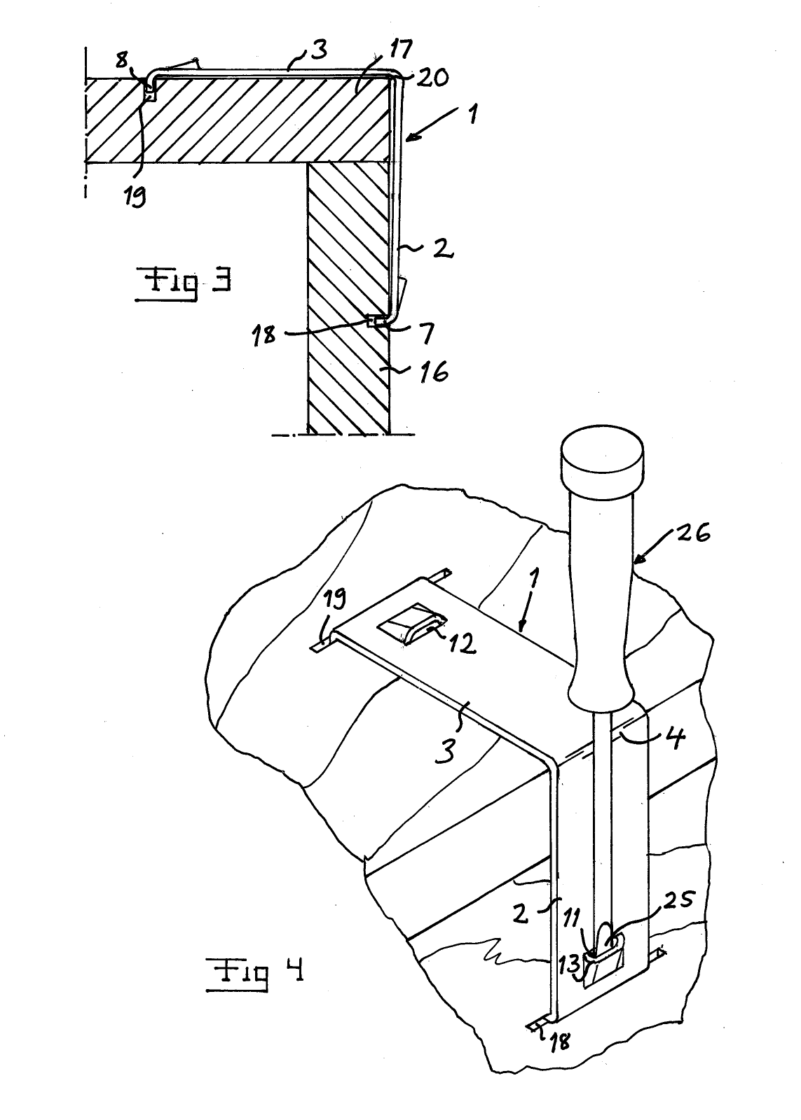

A clamp 1 according to the present invention for interconnecting two plate-like members so as to make them together form a substantially rectangular corner is illustrated in side-elevation in FIG. 1 and in a perspective view in FIG. 2 in a rest state of a minimum of potential energy stored therein. This clamp is designed to interconnect two plate-like members while forming a container, i.e. a bottom, walls and/or a lid of a container. The clamp has two identical legs 2, 3 resiliently connected to each other, which is obtained by manufacturing the clamp of spring steel. Accordingly, a flat spring steel member has been treated to a bent shape for forming said two legs with a transition 4 interconnecting them. The two legs make in the rest position of the clamp shown in FIGS. 1 and 2 an angle α with respect to each other being less than 90°, here approximately 80°.

Each leg has at an outer end 5, 6 thereof remote to said transition 4 a member 7, 8 configured to engage a part of a said plate-like member in a state of interconnecting two said plate-like members. The engagement members are here of the male type and formed by projections making an angle of approximately 90° with respect to adjacent leg portions 9, 10.

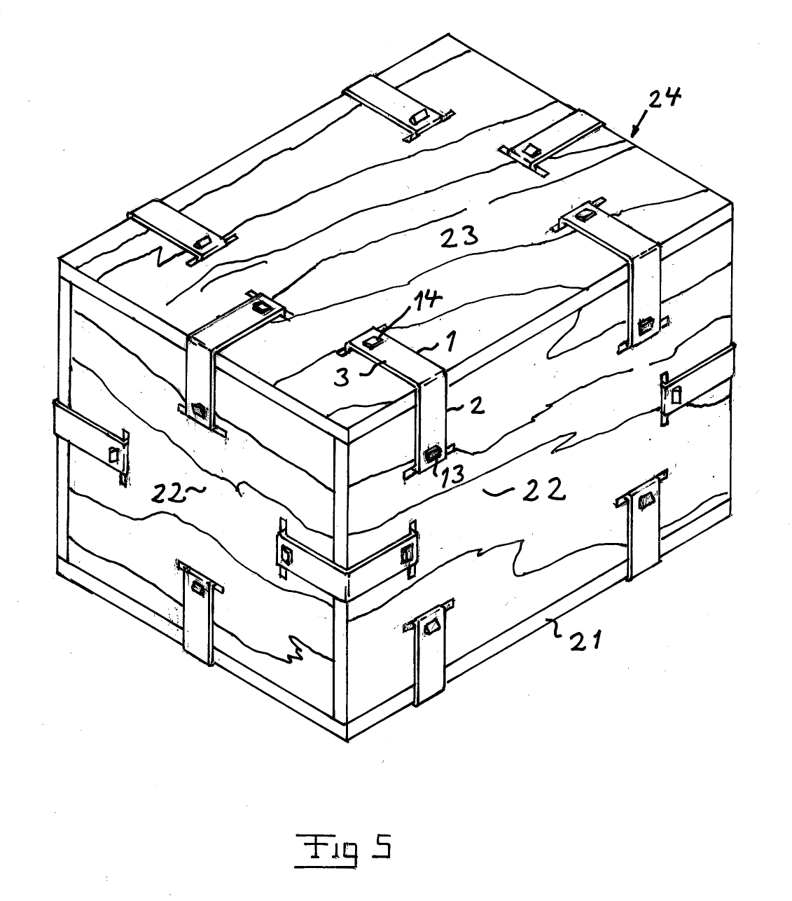

Each leg is provided with an opening 11, 12 designed to receive an end of an elongated tool member in said interconnecting state of the clamp for enabling removal of said clamp in said interconnecting state from said plate-like members, which will be disclosed further below while making reference to FIGS. 3 and 4.

The opening 11, 12 is defined by a member 13, 14 extending out from surrounding portions of the respective leg in the direction towards the transition 4, and this member is formed in one piece with said leg by a portion of leg material bent out from surrounding leg material portions 9, 10. Each such member 13, 14 has a surface 15 diverging from said surrounding leg portions so as to provide support for an end of a said tool member, and this surface makes an angle with respect to said surrounding leg portions of approximately 15° in the embodiment shown. Thus, the surface is configured to be directed towards the plate-like member this leg bears against in the interconnecting state of the clamp.

The function of the clamp shown in FIGS. 1 and 2 will now be explained while making reference to FIGS. 3 and 4. The clamp is brought into a state in which it interconnects two plate-like members 16, 17 so as to make them together form a substantially rectangular corner by introducing the engagement member 7 of one leg 2 into a female member 18, here a groove, in one plate-like member and then urging the other leg 3 apart from the leg 2 while storing potential energy in said clamp and introducing the engagement member 8 of that leg into a female member 19 in the form of a groove in the plate-like member 17. This is easily obtained by pushing the leg 2 close to said transition 4 towards the plate-like member 16. This means that the clamp has been brought into the interconnecting state shown in FIG. 3, in which the clamp extends around a said corner 20 while storing more potential energy than in said rest state and along an outer surface of the plate-like members. Thus, the clamp will efficiently hold the plate-like members together, since the legs will act towards the mutual position thereof shown in FIG. 1.

It is shown in FIG. 5 how a bottom 21, four walls 22 and a lid 23 of a container 24 may be hold together by use of clamps 1 according to the invention as illustrated in FIG. 3. The container is here made of plywood, but any other suitable material is conceivable, such as metal or plastic.

It is illustrated in FIG. 4 how a said clamp may be efficiently removed from the interlocking state shown in FIG. 3 and FIG. 5 without any risk of negative influence upon any plate-like member so as to open a container or disassemble a container for sending the plate-like members thereof further as a flat package. This is obtained by introducing the end 25 of a tool member 26, such as an ordinary screwdriver, into one of the openings 11, 12 of the clamp and urging the engagement member 7, 8 closest to this opening out of engagement with said part (here a groove) of the plate-like member. The end of the tool member will then find support on the surface 15 of the opening defining member 13, 14 in question and thanks to the fact that the opening is directed towards said transition 4 of the legs to each other the tool member may find support by leg portions in the region of the transition 4 while urging the two legs apart for obtaining said removal. This means that it is ensured that the tool member will not act upon any part of the plate-like member in question. It appears that such a removal may be very easy to carry out and obtained in seconds.

The invention is of course not in any way restricted to the embodiment described above, but many possibilities to modifications thereof would be apparent to a person with ordinary skill in the art without departing from the scope of the invention as defined in the appended claims.

The two legs of the clamp may have different dimensions, and it is possible that only one of them is provided with a said opening.

It is also possible to have female engage members at the ends of the legs co-operating with male engagement members on plate-like members.

Said opening of at least one clamp leg has not to extend through that leg, but it may be formed by a cavity with a bottom made in said leg.

1. A clamp (1) for interconnecting two plate-like members (16, 17) to make them together form a substantially rectangular corner (20), said clamp having
two legs (2, 3) resiliently connected to each other, making an angle less than 90° with each other in a rest state of the clamp, and in a state of interconnecting said plate-like members configured to extend around a said corner while storing more potential energy than in said rest state and be located along an outer surface of the plate-like members,
each leg having at an outer end (5, 6) thereof remote to a transition (4) to the other leg, a member (7, 8) configured to engage a part (18, 19) of a plate-like member in said interconnecting state, wherein
at least one of said legs is provided with an opening (11, 12) designed to receive an end of an elongated tool member in said interconnecting state of the clamp for enabling removal of said clamp in said interconnecting state from said plate-like members by influencing that leg in the direction apart from the other leg and moving said engagement member (7, 8) out of engagement with said part of the plate-like member.

2. A clamp according to claim 1, wherein said opening (11, 12) is directed towards said transition (4) of the legs (2, 3) to each other to enable support of a tool member by leg portions in the region of said transition while urging the two legs apart for obtaining said removal.

3. A clamp according to claim 1, comprising a member (13, 14) defining said opening and extending out from surrounding portions (9, 10) of said leg in the direction towards said transition (4).

4. A clamp according to claim 3, wherein said opening defining member (13, 14) has a surface (15) thereof diverging from said surrounding leg portions (9, 10) and providing support for an end of a said tool member.

5. A clamp according to claim 4, wherein said surface (15) of said opening defining member (13, 14) makes an angle with respect to said surrounding leg portions (9, 10) of 5°-30°, 5°-20° or 10°-15°.

6. A clamp according to claim 3, wherein said opening defining member (13, 14) is formed in one piece with said leg by a portion of leg material bent out from surrounding leg material portions (9, 10).

7. A clamp according to claim 1, wherein said clamp is made of one single flat material piece bent in said transition (4) of one leg to the other.

8. A clamp according to claim 1, wherein it is made of metal.

9. A clamp according to claim 8, wherein is made of spring steel.

10. A clamp according to claim 1, wherein said two legs (2, 3) make an angle of 87°-60°, 85°-60°, 80°-60° or 80°-70° in said rest state of a minimum of potential energy stored.

11. A clamp according to claim 1, wherein said engagement member (7, 8) is a male member.

12. A clamp according to claim 11, wherein said male member (7, 8) is formed by an end of said leg (2, 3) projecting from adjacent leg portions (9, 10) while making an angle of approximately 90°, such as 80°-100°, therewith.

13. A clamp according to claim 1, wherein said opening (11, 12) is located close to said outer end (5, 6) of said leg, such as at a distance thereto being less than ⅓, less than ¼, less than ⅕ or less than ⅙ of the distance to the transition (4) of that leg to the other leg.

14. A clamp according to claim 1, wherein both legs (2, 3) each have a said opening (11, 12).

15. A container (24) with at least a bottom (21) and four walls (22) interconnected while together forming substantially rectangular corners of the container, wherein at least adjacent walls of said container are interconnected by at least one clamp (1) according to claim 1.

16. A clamp according to claim 2, comprising a member (13, 14) defining said opening and extending out from surrounding portions (9, 10) of said leg in the direction towards said transition (4).

17. A clamp according to claim 16, wherein said opening defining member (13, 14) has a surface (15) thereof diverging from said surrounding leg portions (9, 10) and providing support for an end of a said tool member.

18. A clamp according to claim 17, wherein said surface (15) of said opening defining member (13, 14) makes an angle with respect to said surrounding leg portions (9, 10) of 5°-30°, 5°-20° or 10°-15°.

19. A clamp according to claim 18, wherein said opening defining member (13, 14) is formed in one piece with said leg by a portion of leg material bent out from surrounding leg material portions (9, 10).

20. A clamp according to claim 17, wherein said opening defining member (13, 14) is formed in one piece with said leg by a portion of leg material bent out from surrounding leg material portions (9, 10).
